(19) United States
(12) Patent Application Publication
(10) Pub. No.: US 2014/0214537 A1
(43) Pub. Date: Jul. 31, 2014

(54) USER TERMINAL AND METHOD AND SYSTEM FOR PROVIDING ADVERTISEMENT

(71) Applicant: SAMSUNG ELECTRONICS CO., LTD., Suwon-si (KR)

(72) Inventors: Seung-yeol YOO, Suwon-si (KR); Hyun-sik SHIM, Seongnam-si (KR); Je-hyok RYU, Suwon-si (KR)

(73) Assignee: SAMSUNG ELECTRONICS CO., LTD., Suwon-si (KR)

(21) Appl. No.: 14/164,689

(22) Filed: Jan. 27, 2014

(30) Foreign Application Priority Data
Jan. 31, 2013 (KR) 10-2013-0011345

(51) Int. Cl. G06Q 30/02

(52) U.S. Cl. CPC G06Q 30/0255
USPC 705/14.53

(57) ABSTRACT

An advertisement providing system is provided. The system includes a first server configured to generate and store user models of interest, based on behavior history information of a user terminal and advertisement-of-interest selection conditions input by a user; a second server configured to generate and store target user attribute models, based on advertisement information and target user selection conditions provided from an advertisement provider; and a third server configured to detect a model by detecting the user models of interest and the target user attribute models based on user information when the user information is transmitted form the user terminal, and recommending an advertisement related to the detected model to the user terminal.

### CROSS-REFERENCE TO RELATED APPLICATIONS

This application claims priority from Korean Patent Application No. 10-2013-0011345, filed on Jan. 31, 2013, in the Korean Intellectual Property Office, the disclosure of which is incorporated herein by reference, in its entirety.

### BACKGROUND

1. Field

Methods and apparatuses consistent with the exemplary embodiments relate to a user terminal and a system and method of providing advertisements. More particularly, the exemplary embodiments relate to an advertisement providing system and a method of semantically interpreting requests from both an advertisement user and an advertisement provider, and selectively providing an advertisement.

2. Description of the Related Art

Known, products or services are advertised to consumers mainly by using medium such as newspaper, magazine, signs, radio, etc. However, as the number of consumers who use a personal terminal device, such as a smart phone, a smart television (TV), a notebook computer, and a personal computer (PC), has recently increased, the number of advertisements provided to terminal devices has increased via various communication networks, such as the Internet and a broadcasting network. Such an advertisement is referred to as a target advertisement since individual characteristics of users can be considered.

However, in the case of known target advertisements, there is no systematic method of support for enabling users of terminal devices, i.e., consumers, to express their preferences for advertisements. Thus, advertisements that are not related to a field of interest of a user are likely to be provided to the user. For example, in the case of a push-type target advertisement which is an advertisement based on location information, when a user who holds a terminal is located at a specific location, advertisements are transmitted to the terminal. However, this method is limited to reflecting matters of interest of the user. Also, since the user is not likely to be interested in the content of an advertisement, not only the effect of the advertisement likely to be low, but the user may also be hostile to receiving the advertisement.

To solve this problem, although matters of interest of users should be reflected in target advertisements, the users are generally passive and negative in inputting their own individual information for advertisements that are not related to matters in which they are interested, thereby degrading the effect and value of advertisements.

An advertisement provider should match a target user with advertisements by collecting and analyzing all available information regarding the user. However, personal information is difficult to collect based on protection of user information and privacy. Furthermore, the precision of a target advertisement is low since information regarding matters of interest that the user actively provides, is insufficient.

Accordingly, there is a growing need for development of a method of enabling a user to express his/her interest regarding and preference for advertisements and a method of enabling a user and an advertisement provider to interactively exchange information that they express.

### SUMMARY

Exemplary embodiments overcome the above disadvantages and other disadvantages not described above. Also, the exemplary embodiments are not required to overcome the disadvantages described above, and an exemplary embodiment may not overcome any of the above-described problems.

The exemplary embodiments provide a user terminal, and an advertisement providing system and method for semantically interpreting requests from both an advertisement provider and a user and selectively providing and using a target advertisement.

According to an aspect of the exemplary embodiments, an advertisement providing system includes a first server configured to generate and store models of user interest, based on history of behavior information of a user terminal and advertisement-of-interest selection conditions input by a user; a second server configured to generate and store target user attribute models, based on advertisement information and target user selection conditions provided from an advertisement provider; and a third server configured to detect a model by detecting the user models of interest and the target user attribute models based on user information, when the user information is transmitted from the user terminal, and is configured to recommend an advertisement related to the detected model.

The user models of interest may include first clustering information obtained by clustering users who are interested in a common advertisement category from the history of behavior information of the user terminal and the advertisement-of-interest selection conditions. The target user attribute models may include second clustering information obtained by clustering user attributes related to a common advertisement category from an advertisement category provided from the advertisement provider and related to attributes of a target user with respect to the advertisement category.

The user history of behavior information may include at least one information from among application execution information, a web browsing history, music or video reproducing information, search keyword information, advertisement receiving information, advertisement clicking information and product purchase information.

The advertisement-of-interest selection conditions may include at least one condition from among the user's age, a place in which a behavior occurs, an advertisement time zone and an advertisement cycle.

The third server may be configured to determine a similarity between the first clustering information and the second clustering information by using a frequent pattern (FP)-tree algorithm, and may be configured to recommend an advertisement related to at least one of the first clustering information and the second clustering information, based on the determined similarity.

The advertisement providing system may further include a fourth server configured to detect a model matching the user information from among the target user attribute models, and may be configured to provide the user terminal with a candidate advertisement list which includes advertisements related to the detected model.

The first server may update the advertisement-of-interest selection conditions according to attributes of at least one advertisement selected from the candidate advertisement list.

The advertisement providing system may further include a fifth server configured to detect a model matching a targeted advertisement input via a terminal of the advertisement provider, from among the user models of interest, and may provide the terminal of the advertisement provider with an attribute list of a candidate user including user attribute information related to the detected model.

The second server may be configured to update the target user selection conditions according to at least one piece of user attribute information selected from the user attribute list.

The advertisement providing system may further include a sixth server configured to generate and store an integrated attribute model by combining at least one user model of interest and at least one target user attribute model, based on common information.

The third server may be configured to detect the integrated attribute model from the sixth server, and may be configured to recommend an advertisement related to the detected model, to the user terminal.

According to another aspect of the exemplary embodiments, a user terminal may include a communicator configured to establish communication with a server; and a display configured to receive and display an advertisement recommended from the server based on user information, when the user information is transmitted to the server via the communicator. The advertisement is related to at least one user model from among user models of interest generated based on history of behavior information of a user terminal and advertisement-of-interest selection conditions input by a user, and may target user attribute models generated based on advertisement information and target user selection conditions provided from an advertisement provider.

According to another aspect of the exemplary embodiments, an advertisement providing method includes generating and storing user models of interest, based on history of behavior information related to a user terminal and advertisement-of-interest selection conditions input by a user; generating and storing target user attribute models, based on advertisement information and target user selecting conditions provided from advertisement provider; and detecting a model by detecting the user models of interest and the target user attribute models based on user information, when the user information is transmitted from the user terminal, and recommending an advertisement related to the detected model

The user models of interest may include first clustering information obtained by clustering users who are interested in a common advertisement category from the behavior history of behavior information of the user terminal and the advertisement-of-interest selection conditions. The target user attribute models may include second clustering information obtained by clustering user attributes related to a common advertisement category from an advertisement category provided from the advertisement provider and from attributes of a target user related to the advertisement category.

The user history of behavior information may include at least one information from among application execution information, a web browsing history, music or video reproducing information, search keyword information, advertisement receiving information, advertisement clicking information and product purchase information.

The advertisement-of-interest selection conditions may include at least one information from among the user's age, a place in which a behavior occurs, an advertisement time zone and an advertisement cycle.

The recommending of the advertisement may include determining a similarity between the first clustering information and the second clustering information by using a frequent pattern (FP)-tree algorithm, and recommending an advertisement related to at least one of the first clustering information and the second clustering information, based on the similarity.

The method of providing an advertisement may further include detecting a model matching the user information from among the target user attribute models, and providing the user terminal with a candidate advertisement list including advertisements related to the detected model.

The method of providing an advertisement may further include updating the advertisement-of-interest selection conditions according to attributes of at least one advertisement selected from the candidate advertisement list.

The method of providing an advertisement may further include detecting a model matching a targeted advertisement input via a terminal of the advertisement provider from among the user models of interest, and providing the terminal of the advertisement provider with a candidate user attribute list including user attribute information related to the detected model.

The method of providing an advertisement may further include generating and storing an integrated attribute model by combining the user models of interest and the target user attribute models, based on common information; and detecting a model by detecting the integrated attribute model, and recommending to the user terminal an advertisement related to the detected model.

According to various exemplary embodiments, requests from both an advertisement provider and a user may be synthetically interpreted and a target advertisement may be selectively provided and used.

An exemplary embodiment may further provide a method of providing advertisement, the method including: generating and storing user models of interest; generating and storing target user attribute models; detecting a model, and recommending an advertisement related to the detected model.

The generating and storing user models of interest may be based on a history of behavior information of a user terminal and advertisement-of-interest selection conditions input by a user.

The generating and storing target user attribute models may be based on advertisement information and target user selecting conditions provided from advertisement provider.

The model may be detected by detecting the user models of interest and the target user attribute models based on user information.

The detecting may occur in response to when the user information is transmitted from the user terminal.

An aspect of another exemplary embodiment may provide an advertisement providing server, the server being configured to transmit an advertisement to a display based on user information; wherein the advertisement transmitted by the server is related to at least one user model of interest from among user models of interest generated based on a history of behavior information of a user terminal and advertisement-of-interest selection conditions input by a user, and based on target user attribute models generated based on advertisement information and target user selection conditions provided from an advertisement provider.

An aspect of an exemplary embodiment may further provide n advertisement providing system including: a server configured to generate and store user models of interest; the server configured to generate and store target user attribute models; and the server configured to detect a model by detecting the user models of interest and the target user attribute models based on user information, and is configured to recommend an advertisement related to the detected model.

The user models may be based on a history of behavior information of a user terminal and advertisement-of-interest selection conditions input by a user.

The user attribute models may be based on advertisement information and target user selection conditions provided from an advertisement provider.

Additional and/or other aspects and advantages of the exemplary embodiments will be set forth in part in the description which follows and, in part, will be obvious from the description, or may be learned by practice of the exemplary embodiments.

### BRIEF DESCRIPTION OF THE DRAWING FIGURES

The above and/or other aspects of the exemplary embodiments will be more apparent by describing certain exemplary embodiments with reference to the accompanying drawings, in which:

FIG. 1 is a block diagram of a structure of an advertisement providing system consistent with an exemplary embodiment;

FIG. 2 is a block diagram of a structure of a user terminal consistent with an exemplary embodiment;

FIG. 3 is a block diagram specifically illustrating the structures of the advertisement providing system of FIG. 1 and the user terminal of FIG. 2;

FIG. 4 illustrates a hierarchical structure of an advertisement category consistent with an exemplary embodiment;

FIG. 5 is a diagram illustrating generating of patterns of interest of an advertisement user consistent with an exemplary embodiment;

FIG. 6 is a diagram illustrating generating of a user target attribute pattern of an advertisement provider consistent with an exemplary embodiment;

FIG. 7 is a diagram illustrating finding and using an integrated model of interest consistent with an exemplary embodiment; and

FIG. 8 is a flowchart illustrating a method of providing an advertisement consistent with an exemplary embodiment.

### DETAILED DESCRIPTION OF THE EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the invention with unnecessary detail.

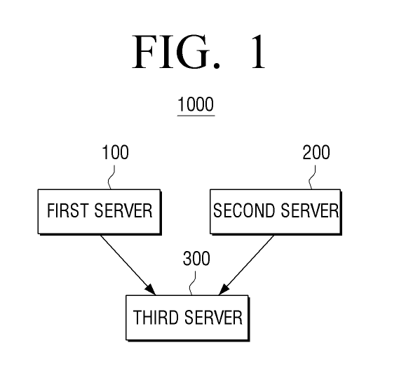

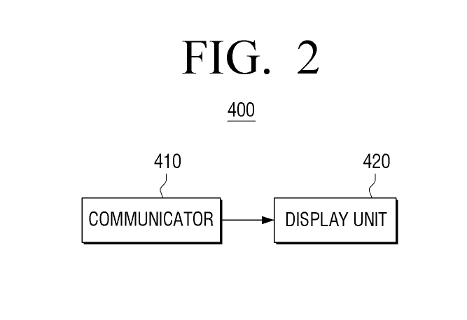

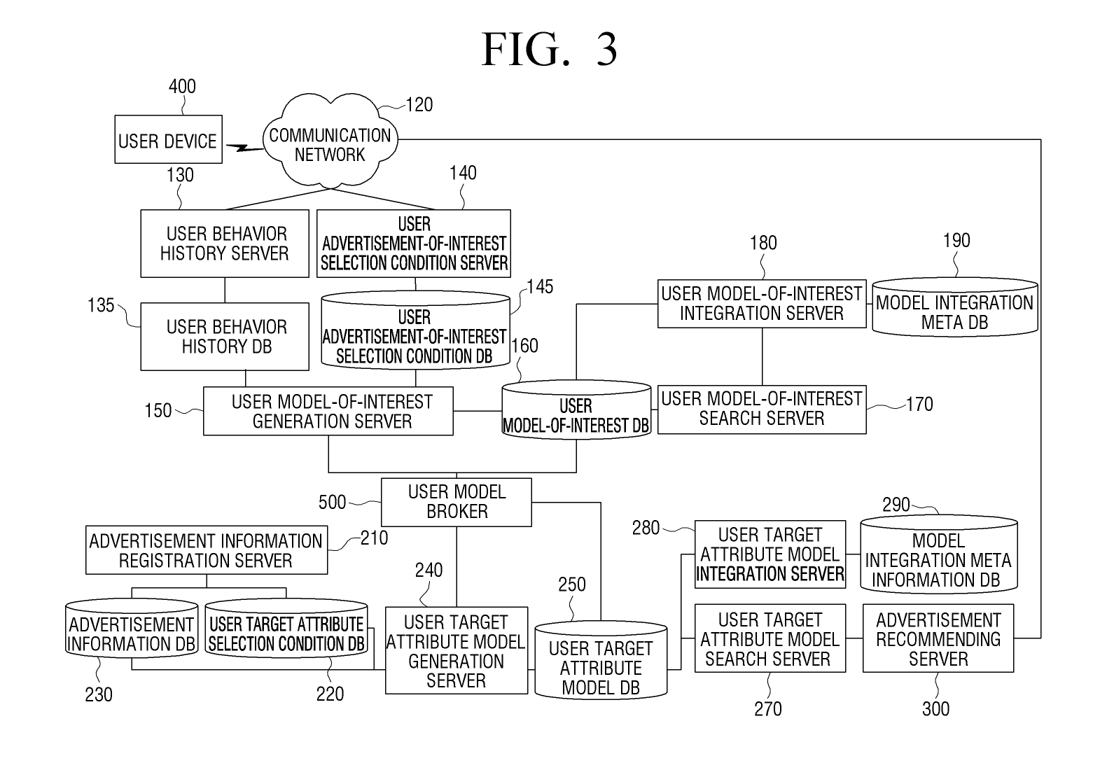

FIG. 1 is a block diagram of a structure of a system 1000 for providing an advertisement according to an exemplary embodiment. FIG. 2 is a block diagram of a structure of a user terminal 400 according to an exemplary embodiment. FIG. 3 is a block diagram specifically illustrating the structures of the advertisement providing system 1000 of FIG. 1 and the user terminal 400 of FIG. 2.

Referring to FIG. 1, the system 1000 for providing an advertisement according to an exemplary embodiment includes a first server 100, a second server 200, and a third server 300. The first server 100, the second server 200, and the third server 300 may be embodied as a plurality of modules included in one server.

The first server 100 generates user models of interest, based on a history of behavior information related to the user terminal 400 and an advertisement-of-interest selection conditions input by a user. To this end, the first server 100 includes a user behavior history server 130, a user behavior history database (DB) 135, a user advertisement-of-interest selection condition server 140, a user advertisement-of-interest selection condition DB 145, a user model-of-interest generation server 150, and a user model-of-interest DB 160 as illustrated in FIG. 3.

A user may provide via user terminal 400 his/her behavior history information and information related to advertisements which he/she is interested in or has a preference for (including advertisement-of-interest selection conditions).

The user behavior history information may include at least one information from among application execution information, a web browsing history, music/video reproduction information, search keyword information, advertisement receiving information, advertisement clicking information and product purchase information.

For example, when a user executes an application for providing information related to a particular automobile, via a smart phone which is an example of the user terminal 400, information regarding the execution of the application on the user terminal 400 is the user history of behavior information. When a particular item is selected or when a particular advertisement is received through the application, information thereof is also included in the user history of behavior information. Basically, it is assumed that information regarding an operation of the user terminal 400 which corresponds to the user's behavior is highly associated with information in which the user is interested.

The advertisement-of-interest selection conditions include at least one condition from among the user's age, a place in which the user's behavior occurs, an advertisement time zone and an advertisement cycle. For example, when the user is in their twenties and operates a user terminal on a university campus, it may be assumed that the user is a university student in their twenties, and this information may be used as a unique attribute of the user. A user who is an analysis target for modeling advertisements of interest, the user's behavior history, a pattern of interest to be generated, and sequential meanings of the pattern of interest may vary according to the user advertisement-of-interest selection conditions.

The user history of behavior server 130 may store and manage information regarding the user's behaviors that are collected via the user terminal 400 (e.g., a search keyword, advertisement clicking, etc.) in the user behavior history DB 135.

The user advertisement-of-interest selection condition server 140 stores and manages information regarding conditions that the user expresses to select his/her advertisements of interest in the user advertisement-of-interest selection condition DB 145, via the user terminal 400. The user advertisement selection condition server 140 may automatically or periodically request an advertisement recommending server 300 (which will be described below) to recommend a new advertisement campaign/item, based on whether or not the user advertisement-of-interest selection condition DB 145 generates an event. The event may be understood to be a case in which the user's new behavior occurs, a case in which advertisement-of-interest selection conditions are newly input, a case in which a request to recommend an advertisement is received from the user terminal 400, etc.

The user model-of-interest generation server 150 generates user models of interest by combining information stored in the user behavior history DB 135 and the user advertisement-of-interest selection condition DB 145. Then, the user model-of-interest generation server 150 stores and manages the generated user models of interest in the user model-of-interest DB 160. In other words, the user model-of-interest generation server 150 may generate a plurality of user models of interest based on a plurality of advertisement selection conditions expressed in the user advertisement-of-interest selection condition DB 145, and may store and manage the plurality of user models of interest in the user model-of-interest DB 160.

The plurality of user models of interest may be frequent association pattern models generated by analyzing history of behavior information of users, based an advertisement category, as will be described below. Also, similar users may be clustered during the generation of the frequent association pattern models.

The second server 200 generates target user attribute models based on advertisement information and target user selection conditions received from an advertisement provider, and stores the target user attribute models. The second server 200 includes an advertisement information registration server 210, an advertisement information DB 230, a user target attribute selection condition DB 220, a user target attribute model generation server 240 and a user target attribute model DB 250.

The advertisement information registration server 210 stores/manages detailed information regarding advertisement campaigns and items provided from an advertisement provider and information regarding user attributes (e.g., demographics, user contexts, etc.) that are to be respectively targeted in units of the advertisement campaigns and the items, in the advertisement information DB 230 and in the user target attribute selection condition DB 220.

The user target attribute model generation server 240 generates user models of interest by combining the information stored in the advertisement information DB 230 and the information stored in the user target attribute selection condition DB 220, and stores and manages the user models of interest in the user target attribute model DB 250.

The user target attribute models may include second clustering information obtained by clustering user attributes related to a common advertisement category from an advertisement category provided from an advertisement provider and attributes of target users related to the advertisement category.

For example, the user target attribute models may generate a frequent association pattern model by analyzing target user attribute information related to advertisement campaigns and items provided from advertisement providers; based on an advertisement category, as will be described below, in detail. Also, user target attributes may be clustered during the generation of the frequent association pattern model.

When the third server 300 (hereinafter referred to as an advertisement recommending server 300) receives user information from the user terminal 400, the third server 300 detects a model by detecting the user models of interest and the target user attribute models based on the user information, and recommends advertisements related to the detected model.

The third server 300 (advertisement recommending server 300) requests a user model-of-interest search server 170 (which will be described in detail below) to detect the user models of interest and requests a user target attribute model search server 270 (which will be described in detail below) to detect the user target attribute models, based on the user information delivered via a communication network 120 from the user terminal 400.

The user model-of-interest search server 170 detects a user category pattern of interest. The user target attribute model search server 270 detects user target attribute information requested by an advertisement provider with respect to a pattern similar to the detected user category pattern of interest.

Then, the advertisement recommending server 300 selects an advertisement campaign and an item to be recommended, based on the detected user models of interest and user target models, and delivers via a communication network 120 the selected advertisement campaign and item to the user terminal 400. Specifically, the advertisement recommending server 300 selects a user target attribute pattern having attributes similar to those of a user from among the detected user target attribute patterns. Then, the advertisement recommending server 300 selects and recommends an advertisement campaign/item that is highly related to the selected user target attribute pattern. The recommendation is provided to user terminal 400.

The advertisement recommending server 300 may use a frequent pattern (FP)-tree algorithm.

The advertisement providing system 1000 of FIG. 1, described above, may further include a fourth server (not shown) configured to detect a model matching the user information from among the target user attribute models. The forth server is additionally configured to provide a candidate advertisement list including advertisements related to the detected model to the user terminal 400.

The advertisement providing system 1000 of FIG. 1, described above, may further include a fifth server (not shown) configured to detect a model matching a targeting advertisement input via a terminal (not shown) of the advertisement provider, from among the user models of interest, and provides to the terminal of the advertisement provider a candidate user attribute list including user attribute information.

The fourth server and the fifth server are illustrated as a user model broker 500 in FIG. 3.

The user model broker 500 may share association information between models of a user interest modeling system (first server) which is configured to model a user in view of an advertisement user and a user target attribute modeling system (second server) which is configured to model a user in view of an advertisement provider. When the advertisement user expresses his/her advertisements of interest, the advertisement provider may provide the advertisement user with candidate advertisement category information based on category information regarding advertisement campaigns/items, which are currently targeted.

In response to the user model-of-interest generation server 150 generating user models of interest, the user model broker 500 searches the user target attribute model DB 250 for advertisement campaigns/items that target attributes similar to those of a user, and provides the user with a candidate list including the advertisement campaigns/items.

The user model broker 500 summarizes attribute information regarding users who are interested in an advertisement category associated with an advertisement to be targeted by an advertisement provider by searching the user model-of-interest DB 160, when the user target attribute model generation server 240 generates user target attribute models. The summary information may be used for selecting the candidate user attribute list by the advertisement provider.

In this case, the first server 100 updates the advertisement-of-interest selection conditions according to attributes of at least one advertisement selected from the candidate advertisement list, and the second server 200 updates the target user selection condition based on at least one user attribute information selected from the candidate user attribute list.

The advertisement providing system 1000 may generate a new model by combining a plurality of models, and may provide an advertisement by using the new model.

To this end, the advertisement providing system 1000 may further include a sixth server (not shown) configured to generate and store an integrated attribute model by integrating at least one user model of interest and at least one target user attribute model, based on common information. In this case, the third server 300 searches the sixth server for the generated integrated attribute model, and recommends an advertisement related to the searched model to the user terminal 400.

The sixth server includes the user model-of-interest search server 170, a user model-of-interest integration server 180, and a model integration meta DB 190 as illustrated in FIG. 3. Also, the sixth server may further include the user target attribute model search server 270, a user target attribute model integration server 280, and a model integration meta information DB 290.

The user model-of-interest search server 170 may detect user models of interest including patterns similar to a given specific pattern from among patterns associated with a plurality of user models stored in the user model-of-interest DB 160. To integrate patterns of interest detected from the plurality of user models of interest, the user model-of-interest search server 170 may request the user model-of-interest integration server 180 to integrate the plurality of patterns of interest.

The user model-of-interest integration server 180 stores meta information obtained by identifying a semantic connection between various user models of interest stored in user model-of-interest DB 160 in the model integration meta DB 190 either periodically, or in response to a request. When integration of the plurality of patterns of interest is requested from the user model-of-interest search server 170, the user model-of-interest integration server 180 generates an integrated pattern of models of interest that comprise given patterns, based on model integration meta information stored therein. The generated integrated pattern of models of interest may be stored in the user model-of-interest DB 160 and may then be reused.

The user model-of-interest integration server 180 may combine a plurality of different user models of interest, based on the model integration meta information stored in the model integration meta information DB 190. For example, meta information representing a semantic relation between concepts used in two different user models expressed using rule-based associations may be expressed with an ontology and stored in the model integration meta information DB 190. A plurality of rule bases may be semantically combined based on integration meta information, and may be integrated into and expressed as one model through a rule generation process.

An integrated user model of interest provides the advertisement recommending server 300 with complex models of interest to be recommended as an advertisement.

The user target attribute model search server 270 may detect a user attribute model including patterns similar to a given specific pattern from among patterns associated with a plurality of user attribute models stored in the user target attribute model DB 250.

To combine attribute patterns detected from among the plurality of user attribute models, the user target attribute model search server 270 may request that the user target attribute model integration server 280 integrate the attribute patterns.

The user target attribute model integration server 280 stores meta information extracted by identifying a semantic connection between various user target attribute models stored in the user target attribute model DB 250 in the model integration meta DB 290 either periodically, or in response to a request.

When integration of a plurality of patterns of interest is requested from the user target attribute model search server 270, an integrated attribute pattern model including given patterns, is generated based on stored model integration meta information. The generated integrated attribute pattern model may be stored in the user target attribute model DB 250 and may then be reused.

The user target attribute model integration server 280 may combine a plurality of different user attribute models based on integration meta information stored in the model integration meta information DB 290. For example, meta information representing a semantic relation between concepts used in two different user target attribute models expressed using rule-based associations may be expressed with an ontology and stored in the model integration meta information DB 290. A plurality of rule bases may be semantically combined based on integration meta information, and may be integrated into and expressed as one model through a rule generation process.

The user terminal 400 described above includes a communicator 410 and a display 420 as illustrated in FIG. 2.

The user terminal 400 may be any of various types of computing devices, including a display. Examples of the user terminal 400 may include various display devices, such as a tablet personal computer (PC), a smart phone, a cellular phone, a PC, a laptop computer, a television (TV), an electronic book, a kiosk, etc.

The communicator 410 may communicate with various servers as described above. Specifically, the communicator 410 may provide a user's history of behavior information to the user behavior history server 130 or may transmit information related to advertisements which a user is interested in or has a preference to (including advertisement-of-interest selection conditions) to the user advertisement-of-interest selection condition server 140. Also, the communicator 410 may detect user models of interest and target user attribute models from the advertisement recommending server 300, and may receive information relating to advertisements recommended in relation to the detected models.

The user terminal 400 communicates with an access point (AP) via a local area network, and exchanges data with a server via the AP. According to an exemplary embodiment, the user terminal 400 has mobility and establishes wireless communication with an AP which is adjacent thereto. In contrast, the AP and the server may be connected via a wired communication device, e.g., the Internet.

The communicator 410 may be embodied according to various local area communication technologies, e.g., WiFi communication standards. In this case, the communicator 410 may include a WiFi module.

According to another exemplary embodiment, the communicator 410 may be embodied according to various mobile communication technologies. In other words, the communicator 410 may include a cellular communication module capable of exchanging data via the existing wireless telephone network. For example, at least one module from among wideband code division multiple access (WCDMA), high-speed downlink packet access (HSDPA), high-speed uplink packet access (HSUPA), and high-speed packet access (HSPA) which are 3-Generation (3G) mobile communication technologies; or one of 2.3 GHz (portable Internet) mobile WiMAX or WiBro and long term evolution (LTE) technology which are 4-Generation (4G) mobile communication technologies may be applied.

At least one module from among a Bluetooth® module, an infrared data association (IrDA) module, a near-field communication (NFC) module, a Zigbee® module, and a wireless LAN module which are local area communication technologies may be employed. Otherwise, another communication technology that is not mentioned herein may be employed, if needed.

The display 420 is configured such that when user information is transmitted to a server via the communicator 410, the display 420 receives and displays an advertisement recommended by the server based on the user information.

The display 190 may be embodied as any of various display devices such as an organic light emitting diode (OLED), a liquid crystal display (LCD) panel, a plasma display panel (PDP), a vacuum fluorescent display (VFD), a field emission display (FED), and an electro luminescence display (ELD). Otherwise, the display 190 may be embodied as a flexible display, a transparent display, or the like.

The advertisement is related to at least one of user models of interest generated based on history of behavior information of a user terminal and advertisement-of-interest selection conditions input by a user, and target user attribute models generated based on advertisement information and target user selection conditions provided from an advertisement provider, as described above.

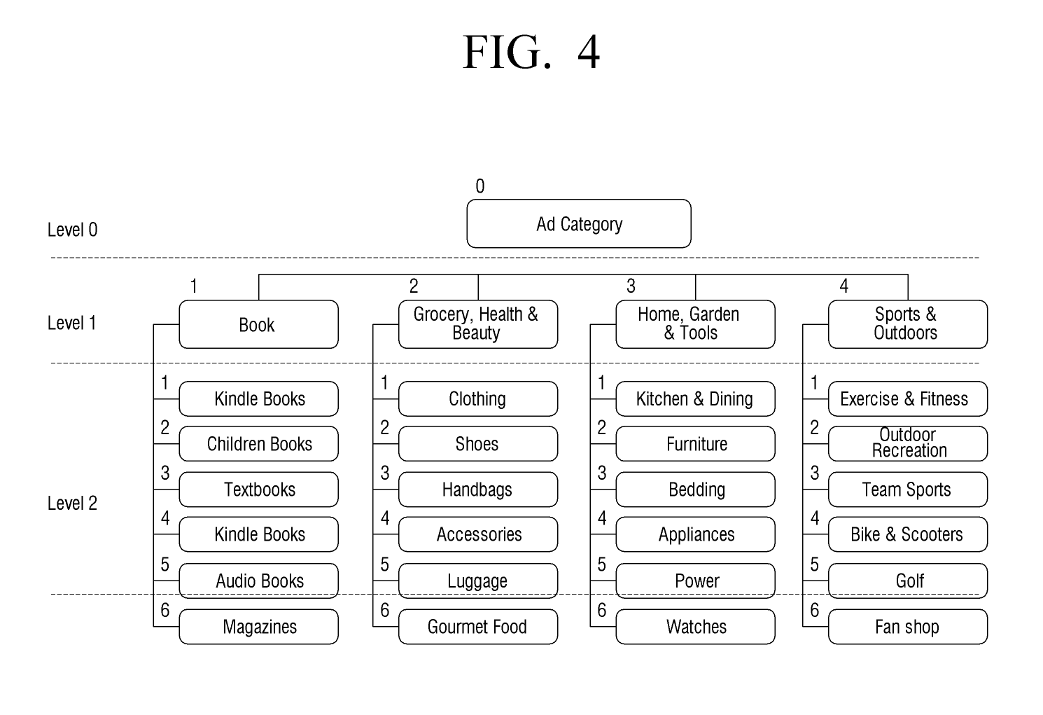

A technique of finding a frequent association pattern using a common knowledge model and clustering similar users in units of categories of interest according to an exemplary embodiment will now be described with reference to FIGS. 4 to 7.

FIG. 4 illustrates a hierarchical structure of an advertisement category according to an exemplary embodiment.

As illustrated in FIG. 4, an advertisement category may be hierarchically classified. At level 1, the advertisement category is categorized into books, grocery/heath & beauty, home/garden & tools, and sports & outdoors.

A plurality of association classification models may be used. For example, user classification models may be classified into occupations (e.g., salary men, housekeepers, independent businessmen) or into ages (20 s, 30 s, 40 s, etc.). Application classification models may be classified into games, health, entertainment, etc. A specific classification model, e.g., an advertisement category, may be used as a model for engaging a plurality of classification models. However, the exemplary embodiments is not limited thereto and various classification methods may be employed.

Identifications (IDs) may be respectively assigned to advertisement categories. A user behavior may be mapped to an advertisement category (ID). For example, a search keyword “Java Programming Language” is mapped to a “Textbooks” (013) category. A search keyword “Handbags” is mapped to a “Handbags” (023) category. Otherwise, mapping may be performed based an application usage history. For example, a case in which a “golf game application” is used is mapped to a “Golf” (045) category.

Also, a user advertisement-of-interest category history is collected. In the embodiment described above, advertisement-of-interest categories of a user U1 include the “Textbooks” (013) category, the “Accessories” (024) category, the “Golf” (045) category, etc.

Also, advertisement campaigns or items that are to be provided from an advertisement provider are expressed by mapping them to advertisement categories. For example, an advertisement item “Ray-Ban Sunglasses RBS-1” is mapped to the “Accessories” (024) category, and an advertisement campaign “Ray-Ban Sunglasses” is assigned to the “Accessories” (024) category.

Also, a user's attributes related to advertisement campaigns or items may be expressed. For example, {“Ray-Ban Sunglasses RBS-1”, (student in twenties)} and {“San Diego Hat,” (student in twenties)} are assigned to the “Accessories” (024) category.

Also, advertisement-of-interest categories of an advertisement provider may be expressed using user attribute conditions. For example, {{“Ray-Ban Sunglasses RBS-1,” “San Diego Hat”}, (student in twenties)} is assigned to the “Accessories” (024) category.

The advertisement providing system 1000 described above may be embodied as any of various types of relational DBS, and a query thereof may be expressed in an SQL language.

For example, restrictions to source data of an analysis of an association pattern that an advertisement user or provider desires to find and a result of analyzing this pattern may be explicitly expressed. To generate a query, commands such as WHO (appoint a user), WHAT (appoint an analysis category), WHERE (appoint a user purchase location), WHEN (appoint year/month/date of interest), PERIOD (appoint an event-of-interest season or a time zone of interest), ORDER (detect a sequential pattern based on year/month/date), may be used.

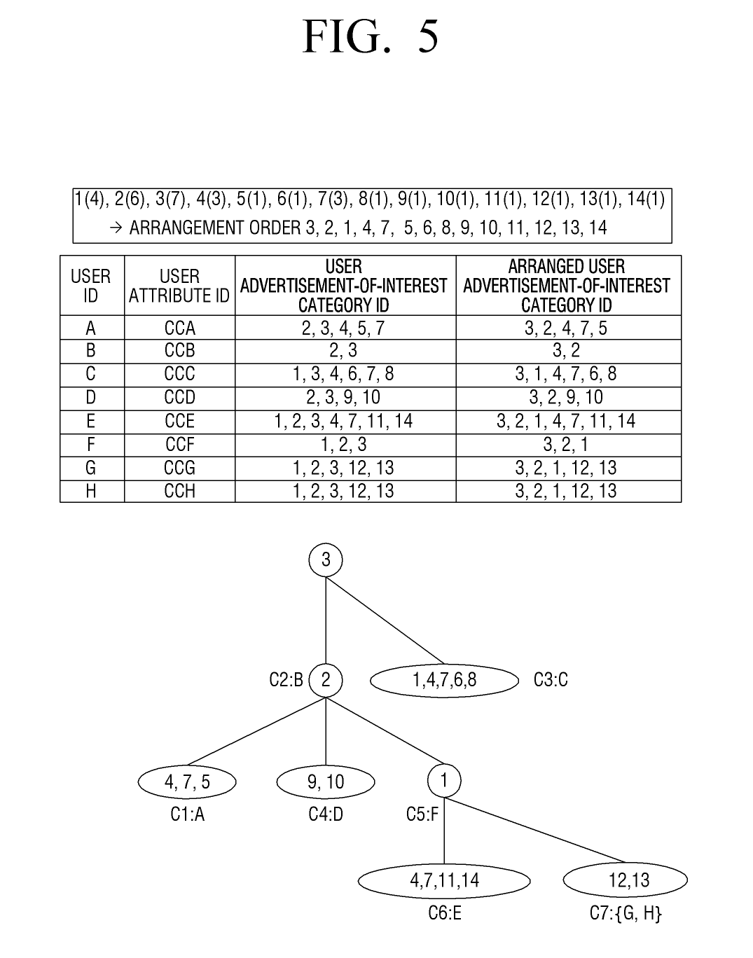

FIG. 5 is a diagram which illustrates generating patterns of interest relating to an advertisement user according to an exemplary embodiment.

Referring to FIG. 5, a frequent association pattern is found based on a user category-of-interest history. In FIG. 5, numbers preceding parentheses, e.g., 1, 2, 3, . . . , denote IDs of categories, and numbers within the parentheses denote the frequencies of the categories. User IDs G and H denote the same attribute and thus form the same node of a tree. Thus, categories of interest of users matching the user IDs G and H are calculated as one category.

Referring to the table of FIG. 5, the category ‘1’ means that a user's behavior of interest occurs four times, the category ‘2’ means that the user's behavior of interest occurs six times, and the category ‘3’ means that the user's behavior of interest occurs seven times. A user's pattern of interest may include at least one of the user history of behavior information and the advertisement-of-interest selection conditions described above. For example, when the user history of behavior information is a web browsing history, the number of times that a user accesses an item related to the category ‘1’ through web browsing may be considered as the user's behavior of interest.

When the frequent association pattern is calculated as described above, a compressed pattern tree is formed based on a pattern of frequent association. Users who are interested in the same advertisement item are similar users and are located in the same node of the compressed pattern tree. In FIG. 5, the user IDs G and H are similar users who have a common category-of-interest pattern {3, 2, 1, 12, 13}.

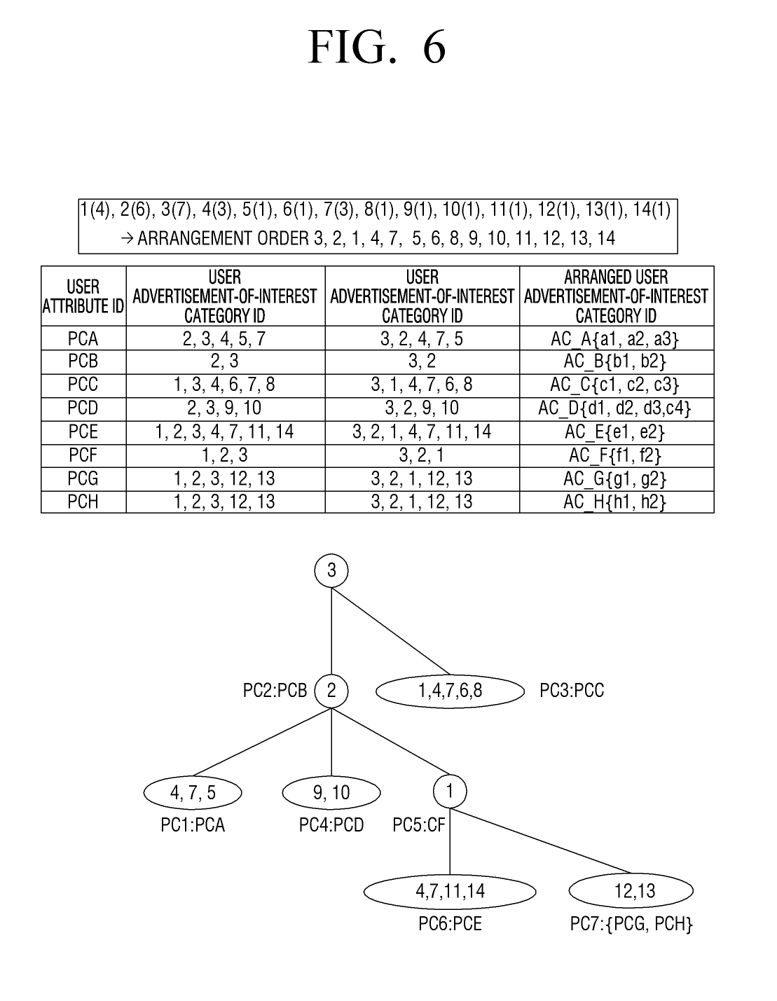

FIG. 6 is a diagram illustrating generating of a user target attribute pattern of an advertisement provider according to an exemplary embodiment.

The user target attribute pattern uses information provided from the advertisement provider. That is, first, advertisement categories related to advertisement items or campaigns are designated. Then, attributes of a target user are designated.

Then, a frequent association pattern between target user attributes related to each of the advertisement items/patterns defined by the advertisement provider and advertisement categories is found. In FIG. 6, numbers preceding parentheses, e.g., 1, 2, 3, . . . , denote IDs of categories, and numbers within the parentheses denote frequencies of the categories. An item is related to each of the categories. For example, a user attribute PCA is related to advertisement-of-interest categories 2, 3, 4, 5, and 7, and items belonging to these categories are AC_A{a1, a2, a3}.

A compressed pattern tree is formed similar to that of the advertisement user pattern of interest. Users who are interested in the same advertisement item are classified as users having similar attributes and are located in the same node of the compressed pattern tree. In FIG. 6, user attributes PCG and PCH are similar user attributes having a common target category pattern {3, 2, 1, 12, 13}.

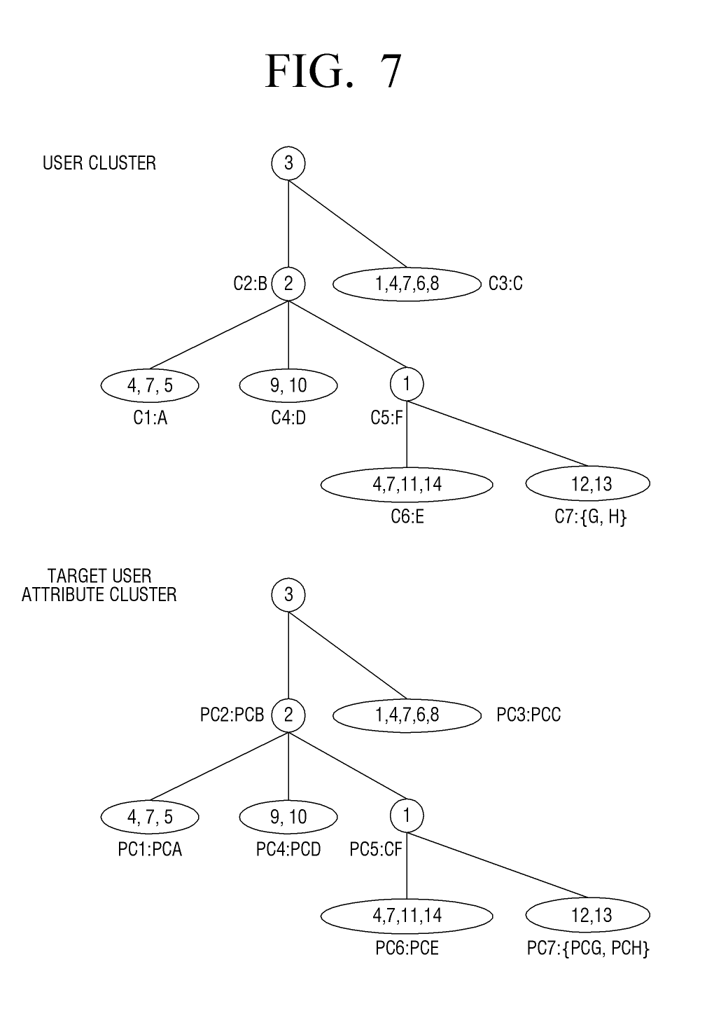

FIG. 7 is a diagram which illustrates finding and using an integrated model of interest, according to an exemplary embodiment.

Referring to FIG. 7, a similarity between clusters present in two different pattern models is determined by combining the pattern of interest model of an advertisement user and the user target attribute pattern model of an advertisement provider as described above. In this case, a general graph similarity measure may be used.

Also, a user cluster and target cluster information are used based on similar advertisement category patterns. For example, by using a user cluster C7 and a target cluster PC7 associated with a common category of interest, an advertisement provider P may selectively express/update attributes of target users thereof, based on user attribute information CCA of the user cluster C7. Also, the advertisement provider P provides target campaigns/advertisements AC_G{g1, g2} and AC_H{h1, h2} to a sub group {H} of a user cluster C7:{G,H} matching an attribute cluster PC7:{PCG, PCH} (on an assumption that CCH⊂C {PCG, PCH}).

A similar user cluster C7:{G,H} selectively expresses/updates attributes of campaigns/advertisements of interest thereof, based on attribute information of target campaign/advertisements AC_G{g1, g2} and AC_H{h1, h2} of the advertisement provider P.

A user models of interest according to an exemplary embodiment may be presupposed as follows:

Rule 1: A∩B∩C→E {U1, U2} (In this case, A, B, C: advertisement categories of interest, E: advertisement of interest, {U1, U2}: Similar users)

Attribute of user U1=UC1,

Attribute of user U2=UC2

In this case, it is assumed that an advertiser user target attribute model is as follows:

Rule 2: B∩C→C1 {I1, I2} (In this case, B, D: advertisement categories of interest, C1: attribute of target user, I1: advertisement campaign/item list to be recommended to users having the attribute C1)

In this case, an integrated model is as follows:

B∩C→E{U1,U2},C1{I1}

In the above exemplary embodiment, an advertisement user is provided with a campaign/item list {I1, I2} that is to be recommended by an advertisement provider, as a selection candidate list. In this case, the advertisement user shares only user history of behavior information regarding advertisement categories B and C included in a user Rule 1 associated with Rule 2 of the advertisement provider with the advertisement provider.

The advertisement provider uses a Rule 1 found by analyzing a user behavior history. Attribute information {UC1, UC2} of similar users {U1, U2} having a pattern of the Rule 1 is used as target user attributes related to advertisements/campaign items associated with the advertisement categories {B, C}.

Advertisement providing methods according to various exemplary embodiments will now be described below.

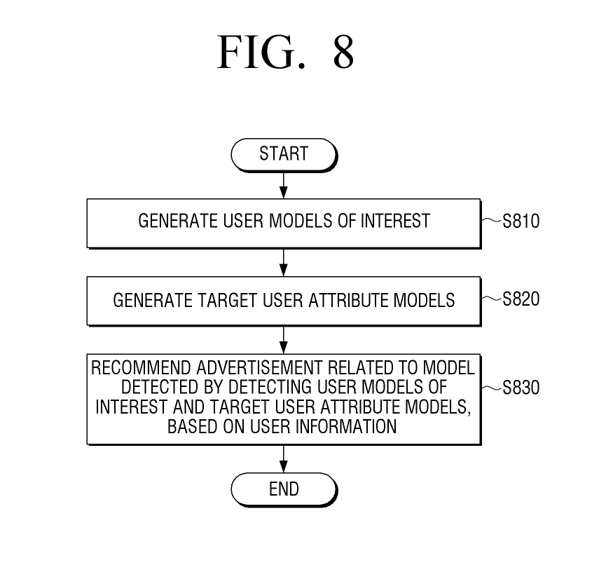

FIG. 8 is a flowchart illustrating a method of providing an advertisement according to an exemplary embodiment.

Referring to FIG. 8, the advertisement providing method according to an exemplary embodiment includes generating user models of interest (operation S810), generating target user attribute models (operation S820), and recommending an advertisement based on transmitted user information (operation S830).

In operation S810, user models of interest are generated and stored, based on history of behavior information of a user terminal and advertisement-of-interest selection conditions input by a user.

In operation S820, target user attribute models are generated and stored, based on advertisement information and target user selection conditions provided from an advertisement provider.

In operation S830, when user information is transmitted from the user terminal, a model is detected by detecting the user models of interest and the target user attribute models based on the user information, and an advertisement related to the detected models is recommended.

In this case, the user models of interest may include first clustering information obtained by clustering users who are interested in a common advertisement category from the history of behavior information of the user terminal and the advertisement-of-interest selection conditions. The target user attribute models may include second clustering information obtained by clustering user attributes related to a common advertisement category, according to advertisement categories provided from the advertisement provider and target user attributes related to the advertisement categories.

Also, the user history of behavior information may include at least one information from among application execution information, a web browsing history, music/video reproduction information, search keyword information, advertisement receiving information, advertisement clicking information and production purchase information.

Also, the advertisement-of-interest selection conditions may include a user's age, a place in which a behavior occurs, an advertisement time zone and an advertisement cycle.

Also, during the recommending of the advertisements (operation S830), a similarity between the first clustering information and the second clustering information may be determined by using a frequent pattern (FP) tree algorithm, and an advertisement related to at least one of the first clustering information and the second clustering information may be recommended based on the similarity.

The method of providing an advertisement may further include detecting a model matching the user information from among the target user attribute models, and providing the user terminal with a candidate advertisement list including advertisements related to the detected model.

The method of providing an advertisement may further include updating the advertisement-of-interest selection conditions according to attributes of at least one advertisement selected from the candidate advertisement list.

The method of providing an advertisement may further include detecting a model matching a targeted advertisement input via a terminal of the advertisement provider from among the user models of interest, and providing the terminal of the advertisement provider with a candidate user attribute list including user attribute information related to the detected model.

The method of providing an advertisement may further include generating and storing an integrated attribute model by combining the user models of interest and the target user attribute models, based on common information, and recommending an advertisement related to a model identified by detecting the integrated attribute model.

Operations of the advertisement providing method have been described above and are thus not described again, herein.

The method of providing an advertisement may be embodied as a program including an algorithm that can be executed in a computer, and may be stored in and provided via a non-transitory computer readable storage medium.

The non-transitory computer readable medium means a recording medium which is capable of semi-permanently storing data other than a recording medium capable of temporarily storing data for a short period (e.g., a register, a cache, a memory, etc.), and from which the data can be read by various devices. Specifically, various applications or programs as described above may be stored in and provided via a non-transitory computer readable medium such as a compact disc (CD), a digital versatile disc (DVD), a hard disk, a Blue-ray Disc™, a universal serial bus (USB) memory, a memory card, a read only memory (ROM), etc.

User terminals and advertisement providing methods and systems according to various exemplary embodiments are capable of enabling a user to select/limit advertisements to be used, thereby minimizing the user's hostility to providing his/her personal information regarding advertisements. Also, information regarding user target attributes related to advertisements that are to be provided may be provided to an advertisement provider, thereby increasing the efficiency of providing advertisements. In addition, explicit/implicit requests regarding usage and providing of advertisements from a user and an advertisement provider may be interactively reflected to increase the efficiency of providing advertisements.

The foregoing exemplary embodiments and advantages are merely exemplary and are not to be construed as limiting. The present teachings can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An advertisement providing system comprising:
a first server configured to generate and store user models of interest, based on a history of behavior information of a user terminal and advertisement-of-interest selection conditions input by a user;
a second server configured to generate and store target user attribute models, based on advertisement information and target user selection conditions provided from an advertisement provider; and
a third server configured to detect a model by detecting the user models of interest and the target user attribute models based on user information, when the user information is transmitted from the user terminal, and is configured to recommend an advertisement related to the detected model.

2. The advertisement providing system as claimed in claim 1, wherein the user models of interest comprise first clustering information configured to be obtained by clustering users who are interested in a common advertisement category from the history of behavior information of the user terminal and the advertisement-of-interest selection conditions,
the target user attribute models comprise second clustering information configured to be obtained by clustering user attributes related to a common advertisement category from an advertisement category provided from the advertisement provider and attributes of a target user related to the advertisement category.

3. The advertisement providing system as claimed in claim 1, wherein the user history of behavior information comprises at least one information from among application execution information, a web browsing history, music or video reproducing information, search keyword information, advertisement receiving information advertisement clicking information and product purchase information.

4. The advertisement providing system as claimed in claim 1, wherein the advertisement-of-interest selection conditions comprise at least one condition from among the user's age, a place in which a behavior occurs, an advertisement time zone and an advertisement cycle.

5. The advertisement providing system as claimed in claim 2, wherein the third server is configured to determine a similarity between the first clustering information and the second clustering information by using a frequent pattern (FP)-tree algorithm, and is configured to recommend an advertisement related to at least one of the first clustering information and the second clustering information, based on the similarity.

6. The advertisement providing system as claimed in claim 1, further comprising a fourth server configured to detect a model matching the user information from among the target user attribute models, and provides the user terminal with a candidate advertisement list including advertisements related to the detected model.

7. The advertisement providing system as claimed in claim 6, wherein the first server is configured to update the advertisement-of-interest selection conditions according to attributes of at least one advertisement selected from the candidate advertisement list.

8. The advertisement providing system as claimed in claim 1, further comprising a fifth server configure to detect a model matching a targeted advertisement input via a terminal of the advertisement provider from among the user models of interest, and is configured to provide the terminal of the advertisement provider with a candidate user attribute list including user attribute information related to the detected model.

9. The advertisement providing system as claimed in claim 8, wherein the second server is configured to update the target user selection conditions according to at least one piece of user attribute information selected from the user attribute list.

10. The advertisement providing system as claimed in claim 1, further comprising a sixth server configured to generate and store an integrated attribute model by combining at least one user model of interest and at least one target user attribute model, based on common information,
wherein the third server is configured to detect the integrated attribute model from the sixth server, and recommends an advertisement related to the detected model to the user terminal.

11. A user terminal comprising:
a communicator configured to establish communication with a server; and
a display configured to receive and display an advertisement recommended from the server based on user information, when the user information is transmitted to the server via the communicator,
wherein the advertisement is related to at least one user model of interest from among user models of interest generated based on a history of behavior information of a user terminal and advertisement-of-interest selection conditions input by a user, and target user attribute models generated based on advertisement information and target user selection conditions provided from an advertisement provider.

12. A method of providing an advertisement, the method comprising:
generating and storing user models of interest, based on a history of behavior information of a user terminal and advertisement-of-interest selection conditions input by a user;
generating and storing target user attribute models, based on advertisement information and target user selecting conditions provided from advertisement provider; and
detecting a model by detecting the user models of interest and the target user attribute models based on user information, when the user information is transmitted from the user terminal, and recommending an advertisement related to the detected model.

13. The advertisement providing method as claimed in claim 12, wherein the user models of interest comprise first clustering information obtained by clustering users who are interested in a common advertisement category from the history of behavior information of the user terminal and the advertisement-of-interest selection conditions, and
the target user attribute models comprise second clustering information obtained by clustering user attributes related to a common advertisement category from an advertisement category provided from the advertisement provider and attributes of a target user related to the advertisement category.

14. The advertisement providing method as claimed in claim 12, wherein the user behavior history information comprises at least one information from among application execution information, a web browsing history, music or video reproducing information, search keyword information, advertisement receiving information, advertisement clicking information and product purchase information.

15. The advertisement providing method as claimed in claim 12, wherein the advertisement-of-interest selection conditions comprise at least one condition from among the user's age, a place in which a behavior occurs, an advertisement time zone and an advertisement cycle.

16. The advertisement providing method as claimed in claim 13, wherein the recommending of the advertisement comprises determining a similarity between the first clustering information and the second clustering information by using a frequent pattern (FP)-tree algorithm, and recommending an advertisement related to at least one of the first clustering information and the second clustering information, based on the similarity.

17. The advertisement providing method as claimed in claim 12, further comprising detecting a model matching the user information from among the target user attribute models, and providing the user terminal with a candidate advertisement list including advertisements related to the detected model.

18. The advertisement providing method as claimed in claim 17, further comprising updating the advertisement-of-interest selection conditions according to attributes of at least one advertisement selected from the candidate advertisement list.

19. The advertisement providing method as claimed in claim 12, further comprising detecting a model matching a targeted advertisement input via a terminal of the advertisement provider from among the user models of interest, and providing the terminal of the advertisement provider with a candidate user attribute list including user attribute information related to the detected model.

20. The advertisement providing method as claimed in claim 12, further comprising:
generating and storing an integrated attribute model by combining the user models of interest and the target user attribute models, based on common information; and
detecting a model by detecting the integrated attribute model, and recommending an advertisement related to the detected model to the user terminal.

21. A method of providing advertisement, the method comprising:
generating and storing user models of interest;
generating and storing target user attribute models;
detecting a model, and
recommending an advertisement related to the detected model.

22. A method of providing advertisement of claim 20, wherein the generating and storing user models of interest is based on a history of behavior information of a user terminal and advertisement-of-interest selection conditions input by a user.

23. The method of providing advertisement of claim 20, wherein the generating and storing target user attribute models is based on advertisement information and target user selecting conditions provided from advertisement provider.

24. The method of providing advertisement of claim 20, wherein the model is detected by detecting the user models of interest and the target user attribute models based on user information.

25. The method of providing advertisement of claim 24, wherein the detecting occurs in response to when the user information is transmitted from the user terminal.

26. An advertisement providing server, the server comprising:
the server being configured to transmit an advertisement to a display based on user information;
wherein the advertisement transmitted by the server is related to at least one user model of interest from among user models of interest generated based on a history of behavior information of a user terminal and advertisement-of-interest selection conditions input by a user, and based on target user attribute models generated based on advertisement information and target user selection conditions provided from an advertisement provider.

27. An advertisement providing system comprising:
a server configured to generate and store user models of interest;
the server configured to generate and store target user attribute models; and
the server configured to detect a model by detecting the user models of interest and the target user attribute models based on user information, and is configured to recommend an advertisement related to the detected model.

28. The advertisement providing system of claim 27, wherein the user models are based on a history of behavior information of a user terminal and advertisement-of-interest selection conditions input by a user.

29. The advertisement providing system of claim 27, wherein the user attribute models are based on advertisement information and target user selection conditions provided from an advertisement provider.
